(19) United States
(12) Patent Application Publication
(10) Pub. No.: US 2026/0356020 A1
(43) Pub. Date: Nov. 12, 2026

(54) APPARATUS AND METHOD FOR OVERMOLDING

(71) Applicant: Biwi S.A., Glovelier (CH)

(72) Inventors: Jonas BOSSHARD, Schaffhausen (CH); Michael AKERMANN, Zurich (CH); Martin EICHENHOFER, Zurich (CH); Jordan KALMAN, Lowell, MA (US); Thomas NETTER, Winterthur (CH); Mateusz STELMASZEK, Warsaw (PL); Przemyslaw ZDROIK, Basel (CH)

(21) Appl. No.: 19/586,207

(22) PCT Filed: Sep. 27, 2024
(86) PCT No.: PCT/EP2024/077373

§ 371 Date: May 8, 2026

(30) Foreign Application Priority Data
Oct. 7, 2023 (EP) EP23202287

(51) Int. Cl. B29C 45/14; B29C 45/00; B29K 101/12; B29K 105/08; B29K 105/16; B29K 701/12; B29L 31/30

(52) U.S. Cl. CPC B29C 45/1418; B29C 45/0005; B29K 2101/12; B29K 2105/0872; B29K 2105/16; B29K 2701/12; B29L 2031/3085

(57) ABSTRACT

A method (5000) for molding first preforms (1110) against second preforms (1120) inside a mold (8000) comprising first (8110) and second (8120) mold components, the method comprising: deforming (5200) the preforms (1110, 1120) by adjusting (5210) a position (8305) of the mold components for pressing (5250) the first preforms against the second preforms in the mold; and overmolding (5300) the preforms inside the mold by injecting (5320) a thermoplastic resin causing a flow direction (8215FD) of overmolding material inside the mold, wherein the preforms comprise a thermoplastic resin and wherein the deforming comprises controlling (5100): a force of the deforming; a temperature of the deforming setting the preforms at temperatures (1100T) above a glass transition temperature (1100TG) and below a melting temperature (1100TM) of the preforms; and iii) a temperature (5400MT) of the mold.

### FIELD

This disclosure relates methods and systems for molding preforms into parts, for example into parts comprising fibers.

### SUMMARY

This disclosure presents a method for molding one or more first preforms against one or more second preforms inside a mold comprising a first mold component and a second mold component, the method comprising the steps: deforming one or more of the preforms by adjusting a position of one or more of the mold components configured for pressing one or more of the first preforms against one or more of the second preforms in an inside of the mold; and overmolding at least a portion of one or more of the preforms inside the mold, wherein the overmolding comprises injecting an overmolding material comprising an overmolding thermoplastic resin and causing a flow direction of the overmolding material along at least a portion of the inside of the mold, wherein each of the preforms comprises a thermoplastic resin and wherein the deforming comprises controlling: i) a force of the deforming exerted by one or more motion actuators at one or more of the positions of the mold components, wherein the motion actuators are connected to one or more of the mold components and having an actuation range extending via a plurality of the positions of one or more of the mold components from one or more of an open mold position configuration to a closed mold position configuration; ii) a temperature of the deforming at one or more of the positions of one or more of the mold components, wherein the temperature of the deforming sets one or more of the first preforms and one or more of the second preforms against which the first preforms are pressed to be at one or more preform temperatures that are above a glass transition temperature and below a melting temperature of the preforms; and iii) a temperature of the mold during the step of overmolding wherein one or more of the mold components are configured in the closed mold configuration.

This disclosure further presents A mold for molding one or more first preforms against one or more second preforms, the mold comprising: one or more first mold components and one or more second mold components; one or more motion actuators connected to one or more of the mold components and having an actuation range extending via a plurality of mold positions from one or more of an open mold position configuration to a closed mold position configuration; one or more heating devices, each connected to one or more of the mold components, for heating one or more of the mold components and the preforms; one or more outlets feeding into an inside of the mold; and a controller connected to one or more of the heating devices and to one or more of the motion actuators, wherein the controller comprises instructions for: i) adjusting a force exerted by one or more of the motion actuators at one or more of the mold positions; ii) adjusting a temperature at one or more of the mold positions within the actuation range; and iii) adjusting an overmolding temperature of the mold for overmolding upon one or more of the mold components being configured in the closed mold configuration.

### BRIEF DESCRIPTION OF DRAWINGS

FIG. 1 is a side view of an overmolding system comprising an injection unit.

FIG. 2A is an isometric view of a filament comprising continuous fibers, configured as a tape.

FIG. 2B is an isometric view of a filament comprising discontinuous fibers, configured as a tape.

FIG. 2C is a side view of a filament deposition system onto a substrate.

FIG. 2D is a side view of a substrate comprising a stack comprising a plurality of filaments.

FIG. 3A is a top view of a substrate onto which 2 rib preforms and a flange preform have been formed by depositing a plurality of filaments.

FIG. 3B is an isometric view of a rib preform comprising a stack of filaments and, at a plurality of locations, a compound.

FIG. 3C is a top view of a first part in a mold onto which 2 rib preforms, a flange preform have been placed and wherein a fourth preform has filaments arranged in a snaking pattern.

FIG. 4 is a top view of a second part in a mold onto which 2 rib preforms and a flange preform have been placed and wherein the flange preform has filaments arranged in a snaking pattern.

FIG. 5A is a top view of a substrate comprising a first preform and a second preform configured as horseshoes.

FIG. 5B is a top view of a mold wherein a first horseshoe preform is placed over a second horseshoe preform.

FIG. 5C is a side view of a mold wherein a first horseshoe preform has been pressed against a second horseshoe preform.

FIG. 5D is an isometric view of a third part configured as a horseshoe.

FIG. 6A is a top view of a substrate comprising 2 flange horseshoe preforms and a web preform arranged for bending into a horseshoe and comprising filaments arranged in a snaking pattern.

FIG. 6B is a side view of a mold into which the web preform of FIG. 6A has been bent into a horseshoe configuration and sandwiched between 2 flange horseshoe preforms pressed against it.

FIG. 6C is an isometric view of a fourth part configured as a horseshoe.

FIG. 7A is a top view of a horseshoe preform comprising a plurality of filament stack portions.

FIG. 7B is a side view of a mold into which the web preform of FIG. 6A has been bent into a horseshoe configuration and sandwiched between a first and a second horseshoe preforms of FIG. 7B pressed against it.

FIG. 7C is an isometric view of a fifth part configured as a horseshoe.

FIG. 8A is a top view of a horseshoe flange preform configured with a base to be pressed against a horseshoe web preform comprising a bridge configured with a snaking pattern.

FIG. 8B is a side view of a mold into which the horseshoe flange preform of FIG. 8A has been pressed against the horseshoe web preform comprising a bridge.

FIG. 8C is an isometric view of a sixth part configured as a horseshoe having a bridge.

FIG. 9 is a block diagram of a computer system or controller used to control one or more of a deposition system and a molding system.

FIG. 10 is a block diagram of a method for molding one or more preforms into a part.

FIG. 11A is a side view of the molding unit of the molding system of FIG. 1 in an open configuration.

FIG. 11B is a side view of the molding unit of the molding system of FIG. 1 in a closed configuration.

FIG. 12 is a mold or preform temperature vs. mold position diagram during a step of deforming.

FIG. 13 is a mold or preform temperature vs. time diagram during a step of overmolding.

### DETAILED DESCRIPTION

This disclosure relates to methods and systems for molding preforms into parts, for example into parts comprising fibers. For example, the molding method 5000 comprises a two-step process wherein in a first step one or more preforms are one or more of deformed 5200 and pressed 5250 against each other in an overmolding system 8000 comprising one or more molding units 8100, for example at a temperature comprised in range between a glass transition temperature and a melting temperature of one or more of the preforms, and in a second step, for example within the same molding unit, the pressed preforms are subjected to an overmolding process 5300 wherein a fluid thermoplastic material is progressively injected at one or more controlled rates into the molding unit and maintained under one or more controlled pressures. In the rest of this description, glass temperature and melting temperature refer to that of a resin, for example of a thermoplastic resin, for example impregnating fibers, for example of a filament or tape 110.

A preform 1110, 1120 is, for example, a device comprising a thermoplastic material. For example, a preform comprises one or more filaments 110, 110FD, for example arranged in a layup 1110LU, 1120LU comprising one or more layers 201, 202. For example, a preform comprises one or more organosheets. For example, a preform is a part comprising a thermoplastic polymer that is permanently deformable to attain one or more of an intermediate or final configuration under one or more of pressure and temperature. Examples of thermoplastic polymers include PA6, PA12, PEEK, and PAEK. For example, one or more preforms are or have been subjected to one or more of deforming and bonding in a mold, for example by subjecting the preforms to one or more of a deforming step, a bending step, a pressing step, a stamping step, a compression molding step, and an injection molding step.

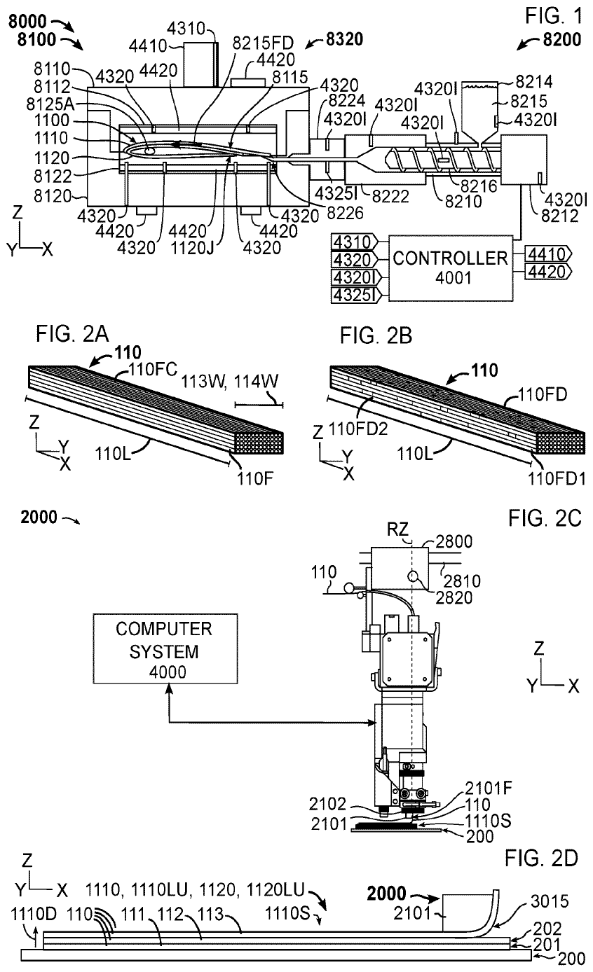

FIG. 1 is a side view of an overmolding system 8000 comprising a molding unit 8100 in a closed mold configuration 8320 and an injection unit 8200. For example, the molding unit comprises one or more first mold components, for example configured as one or more piston components 8110, for example configured as a plunger, and one or more second mold components 8120, for example against which one or more of the first mold components press. For example, the molding unit 8100 comprises sub-mold components 8112, 8122, for example arranged between the mold components 8110, 8120 and the material, for example comprising one or more of the preforms, to be molded. For example, one or more first sub-mold components 8112 are fixed to one or more of the first mold components and one or more second sub-mold components 8122 are fixed to one or more of the second mold components.

For example, the sub-mold components comprise a material having a melting temperature that is higher than that of the preforms, for example than the thermoplastic polymer comprised in the preforms. For example, the sub-mold components comprise, for example are made of, one or more of: a metal, for example a steel, for another example, an aluminum, for example an aluminum alloy; a polymer, for example comprising one or more of a thermosetting, a thermoplastic, and a photopolymer, for example a polymer comprising fibers; and a salt. For example, one or more of the sub-mold components are manufactured using one or more of a subtractive manufacturing process, for example milling, a molding process, and an additive manufacturing process. Examples of additive manufacturing processes include one or more of photopolymerization, material jetting, binder jetting, powder bed fusion, material extrusion, directed energy deposition such as powder-fed directed-energy deposition or selective powder deposition, sheet lamination, and ultrasonic consolidation of materials. For example, one or more of the sub-mold components comprise a coating, for example one or more of a metallic coating and a ceramic coating. For example, one or more of the sub-mold components has one or more textures on, for example, one or more of the surfaces facing the inside of the mold. For example, upon molding, one or more of the surfaces of the sub-mold components is coated with a molding release agent, for example comprising a solvent, for example comprising one or more of a wax, a fatty ester, a silicone, and a metallic soap.

For example, one or more of the mold components 8110, 8120 and sub-mold components comprise one or more sensors 4300 and actuators 4400 (FIG. 9), for example temperature sensors 4320, one or more heating actuators 4420, and motion sensors 4310, for example embedded in one or more motion actuators 4410, for example configured for displacing one or more of the mold components and sub-mold components, for example for pressing 5250 one or more of the preforms, for example preforms having at least a portion of the preform inside the molding unit 8100. FIG. 1 shows a motion actuator 4410 for displacing a top or first mold component 8110 and a top or first sub-mold component 8112 in a −Z-direction, for example downwards, against a bottom or second mold component 8120 and a bottom or second sub-mold component 8122, for example to mate from an open configuration shown in FIG. 11A to a closed configuration shown in FIG. 1 and in FIG. 11B. In other examples, not shown, one or more mold components or sub-mold components, are configured to displace, for example one or more of translate and rotate, in one or more directions, for example under the action of further actuators or through sliders set in motion by contacting one or more of the mold components and sub-components. For example, a heating actuator 4420 comprises one or more heating elements and one or more cooling elements. For example, a heating element comprises one or more of resistors and ducts, for example for driving a heating fluid. For example, a cooling element comprises one or more ducts, for example for driving a cooling fluid. For example, the heating elements are arranged along one or more surfaces of one or more of the mold components and sub-mold components. For example, one or more of a heating element and a cooling element is arranged to surround a mold component, for example in a plane parallel to the X-Y plane, as shown in FIG. 1.

For example, the overmolding system 8000 comprises one or more injection units 8200. The injection unit comprises a motor 8212 turning a screw 8216 for drawing in a material to be injected 8215, for example in the form of granules, pellets, or chips, from a hopper 8214 into a barrel 8210 that is, for example, a heating barrel. The screw 8216 is, for example, a non-reciprocating screw. In another example, the screw 8216 is a reciprocating screw. The path of the material continues onward to one or more of: a converging duct 8222 that is, for example, a heating converging duct; a junction duct 8224, for example a heating junction duct, connecting the injection unit 8200 to the molding unit 8100; and an outlet 8226, feeding for example through one or more of the mold components and the sub-mold components into an inside of the mold 8115. For example, one or more components of the injection unit 8200, for example one or more of the motor 8212, the hopper 8214, the barrel 8210, the screw 8216, the converging duct 8222, the junction duct 8224, and the outlet 8226 comprise one or more temperature sensors 43201. For example, one or more components of the injection unit 8200, for example one or more of the hopper 8214, the barrel 8210, the screw 8216, the converging duct 8222, the junction duct 8224, and the outlet 8226 comprise one or more pressure sensors 4325I. For example, the overmolding system 8000 is used to apply one or more of a stamping method, a compression molding method, and an overmolding method onto a preform comprising fibers, for example a preform comprising filaments or tows comprising fibers impregnated by a polymer.

For example, the overmolding system 8000, for example one or more of the molding unit 8100 and the injection unit 8200, is connected to a controller 4001, for example also represented as the computer system 4000 (FIG. 9). For example, the controller 4001 receives input signals or data from one or more sensors 4300, for example one or more of one or more motion sensors 4310 and one or more temperature sensors 4320 and generates output signals or data to one or more actuators 4400, for example to one or more of the motion actuators 4410 and of the heating actuators 4420. For example, the controller comprises instructions, for example stored on a non-transitory computer-readable storage medium (NTCRSM) 4120, to generate commands sent to the actuators as a function of, for example based on, one or more of sensory data values and time, for example of a time-based command sequence stored in a table.

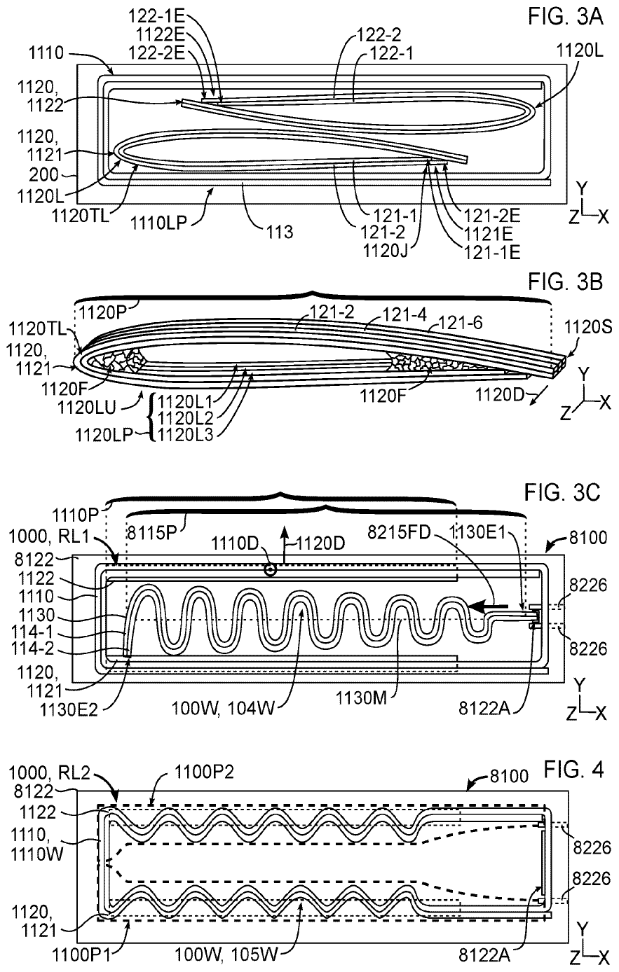

FIG. 1 further shows one or more first preforms 1110 pressed against one or more second preforms 1120. For example, a first surface portion 1110P of the first preform 1110 contacts a second surface portion 1120P of the second preform 1120. For example, a deforming step 5200, for example including a pressing step 5250, deforms the first preform 1110 from a first configuration from, for example, a flat configuration, into a second configuration, for example comprising one or more of curves and folds resulting from one or more of deforming and pressing the one or more preforms one or more of prior to insertion in the mold and during placement inside the mold, for example during transition from a mold's open configuration 8310 to the mold's closed configuration 8320. For example, FIG. 1 further shows an arrow 8215FD indicating a dominant direction of injection molding material flow, for example from one or more first ends of the mold where one or more of the outlets 8226 are located towards one or more second ends wherein air inside the mold evacuates as the injection molding material progresses into the inside of the mold. For example, the step of overmolding 5300 with, for example, a molten thermoplastic resin, causes a flow direction 8215FD of the overmolding material along at least a portion of the inside 8115P (FIG. 3C) of the molding unit 8100. For example, one or more of the preforms are anchored 5005 into the mold by one or more pins 8125A, for example inserted into the mold after insertion of one or more of the preforms, for example after insertion of the second preforms 1120. For example, a portion of one or more of the preforms are placed in one or more of in the mold, against the mold, and in a position for pressing against one or more surfaces of the mold. For example, the placing comprises positioning the one or more preforms into the mold using one or more of a robotic manipulator, a conveyor, and a dispenser. For example the placing is assisted by one or more of: gravity; a slider, for example for guiding the dispensed preform or a component into position; a conveyor; a vibrator; a blower; an adhesive, for example comprising one or more of a liquid and a molten adhesive; and an optoelectronic measurement device, for example an imaging device.

FIG. 2A is an isometric view of a filament 110, for example a filament 110FC comprising a plurality of continuous fibers 110F. For example, the filament 110 is configured as a tape having a width 113W, 114W. For example, a preform 1110, 1120 comprises a first filament having a first width 113W. For example a tape, having a rectangular cross-section, confers placement, anchoring, and filament path forming characteristics, especially in tight turns, that have greater stability than filaments having a rounded cross-section. For example, the preform comprises a second filament 114 having a second width 114W that is different from the first width. For example, the fibers 110F extend continuously along an entire length 110L of the filament 110. FIG. 2B is an isometric view of a filament 110, for example a filament 110FD comprising discontinuous fibers 110FD1, 110FD2, for example configured as a tape.

For example, the filament is a pre-impregnated, also called prepreg, filament. For example, the prepreg filament comprises fibers pre-impregnated with a thermoplastic resin. For example, a filament comprises one or more of a tow, a roving, a tape, a commingled yarn, or a combination thereof. For example the combination is in one or more of: i) a parallel arrangement; and ii) a sequential arrangement along the longitudinal direction of the filament. For example, the filament comprises one or more thermoplastic resins. For example, the filament is preimpregnated with one or more thermoplastic resin. For a further example, the filament is impregnated with one or more thermoplastic resins within 10 minutes prior to or upon deposition of the filament onto a substrate. For example, the filament comprises one or more of: a plurality of continuous fibers, a plurality of discontinuous fibers, and a plurality of chopped fibers.

For example, a filament comprising a plurality of discontinuous fibers comprises one or more sets of discontinuous fibers arranged as a plurality of parallel fibers. For example, the fibers in a filament comprising discontinuous fibers have a uniform length. For example, the discontinuous fibers have a length comprised in a range from 2 mm to 20 mm, for example from 2 mm to 10 mm, for example from 3 mm to 8 mm, for example from 3 mm to 6 mm. For example, the length-to-diameter ratio of a discontinuous fiber is in a range from 500 to 1500, for example from 600 to 1200. For example, a fiber having a length that is greater than that of a discontinuous fiber is a continuous fiber. For example, a fiber having a length that is less than that of a discontinuous fiber is a chopped fiber. For example, the discontinuous fibers are arranged parallel to the longitudinal direction of the filament. For example, at least 50%, for example more than 75%, for example more than 90%, for example more than 95% of the fibers are parallel to the longitudinal direction of the filament, for example within 15° of the longitudinal direction of the filament, for example within 10°, for example within 5°.

For example, the filament has a filament width 113W, 114W. For example, the width of filament 110 is comprised in a range from 0.2 mm to 10 mm, for example from 0.4 mm to 5 mm, for example from 0.4 mm to 3 mm, for example from 0.4 mm to 2 mm, for example from 0.4 mm to 1 mm, for example from 0.45 mm to 0.6 mm. For example, a tape is formed by cutting a sheet or a web comprising a plurality of fibers in a direction parallel to the fibers. For example, a filament, for example a tape, has a width 113W in a range from 0.4 mm to 3 mm, for example from 0.6 mm to 2 mm, for example from 0.8 mm to 1.5 mm, for example from 0.9 mm to 1.2 mm.

For example, a filament comprises one or more fiber materials, for example selected from one or more of: a carbon fiber, a glass fiber, an aramid fiber, a basalt fiber, a metal fiber, and a natural fiber. For example, a natural fiber comprises fiber extracted from one or more of: a sisal, a flax, a ramie, a cotton, a banana, a hemp, and a byssus. For example, a set of continuous fibers or a set of discontinuous fibers comprises fibers of one or more of the fiber materials.

For example, the one or more filament is impregnated with an adhesive material, for example a thermoplastic adhesive. For example, a thermoplastic adhesive comprises one or more of: a polyaryletherketone (PAEK), a polyether ether ketone (PEEK), a polyetherketoneketone (PEKK), a polyetherimide (PEI), an acrylonitrile butadiene styrene (ABS), a nylon, a polybutylene terephthalate (PBT), a polycarbonate (PC), a polycarbonate-ABS (PC-ABS), a polyether sulfone (PES), a polyethylene (PE), a polyamide (PA), a polyimide (PI), a polyethylene terephthalate (PET), a polyphenylene sulfide (PPS), a polyphenylsulfone (PPSU), a polyphosphoric acid (PPA), a polypropylene (PP), a polysulfone (PSU), a polyurethane (PU), and a polyvinyl chloride (PVC).

For example, a thermoplastic further comprises a filler material. For example, a filler material comprises one or more of: a plurality of microspheres, a plurality of chopped fibers, and a plurality of one or more discontinuous fibers, short fibers, chopped fibers, and recycled fibers.

For example, the filament comprises a slit tape, for example obtained by cutting one or more sheets or tapes comprising unidirectional fibers. For example, the filament further comprises a coating, for example comprising a thermoplastic resin. For another example, the filament comprising fibers is one or more of impregnated and coated, for example with a thermoplastic material, within a filament deposition system. For yet another example, the filament is a rod, for example a profiled rod, for example formed by one or more of an extrusion and a pultrusion process, and subjected to a bending or folding step along the longitudinal direction of the rod, for example by heating the rod at least where one or more of the bends are to be formed. For example, the rods are assembled, for example bonded together, prior to insertion into the molding unit 8100.

For example, a profiled rod is formed by extrusion of a material comprising a plurality of non-aligned fibers and one or more resins. For example, a profiled rod is formed by pultrusion of a material comprising a plurality of co-aligned continuous fibers and one or more resins. For example, a resin comprised in a profiled rod is a thermoplastic resin. For example, a profiled rod comprises a coating, for example comprising a thermoplastic resin, on its exterior surface. For example, a profiled rod comprises from 5 fibers to 10 million fibers, for example from 5 to 1 million fibers, for example from 5 to 100000 fibers, for example from 5 to 50000 fibers, for example from 1100 to 40000 fibers, for example from 1100 to 5000 fibers. For example, a profiled rod has one or more of bends and folds. For example, a profiled rod has a circular cross-section. Any other cross-section geometry is possible, for example oval, rectangular, or comprising a plurality of straight and rounded contours, for example as defined by the contour of an aperture of one or more of an extrusion process and a pultrusion process used for producing the raw profiled rod.

FIG. 2C is a side view of a filament deposition system (FDS) 2000 for depositing a filament 110, 110FC, 110FD onto, for example, a substrate 200 or onto other material, for example onto one or more of: filaments, layers 201, 202 (FIG. 2D) comprising filaments, and stacks 1110S of layers of material. For example, the FDS is a fused deposition modeling (FDM) system. For example, the FDS 2000 comprises a slide head 2800 comprising one or more axes 2810, 2820. For example, the slide head 2800 comprises a first axis 2810 that is orthogonal to a second axis 2820. For example, the FDS 2000 comprises a rotating foot device 2101 connected to a rotating support 2102, for example rotating around a rotating axis RZ, for example parallel to the Z-axis. For example, one or more of the axes 2810, 2820 is intersected by the Z-wise extension of the rotating axis RZ. For example, the FDS is connected to a computer system 4000, for example for controlling the position of one or more of the FDS 2000 and the substrate or build plate 200 in one or more of, for example, the X, Y, and Z directions. For example, the computer system 4000 comprises instructions, for example stored in the NTCRSM 4120, to control the rate of motors supplying the filament 110 to the substrate 200, whether in a traction configuration mode, for example powered, or in a free-wheeling mode, for example unpowered, for example via a pinch wheel arrangement (not shown) embedded inside the FDS 2000. For example, instructions of the computer system 4000 further control one or more of a heating element and a cooling element comprised in the FDS 2000 and used, for example, for one or more of heating and cooling the filament 110. For example, the FDS 2000 is used to manufacture one or more preforms onto the substrate 200, for example prior to insertion into the overmolding system 8000. For a further example, the FDS 2000 is used to manufacture or bind together one or more preforms, for example inside the overmolding system 8000 or the molding unit 8100, for example with the mold in an open configuration 8310. For yet a further example one or more inserts, for example metal inserts, are positioned in one or more of the preforms and the mold prior to initiating the step of overmolding 5300.

Other examples for a filament deposition system having a configuration that is different from that shown in FIG. 2C include a fi

FIG. 2D is a side view of a substrate 200 supporting or comprising a preform 1110, 1120 comprising one or more stacks 1110S, for example extending in a first stack direction 1110D, for example comprising a plurality of filaments 110, 111, 112, 113 for example arranged in a layup 1110LU, 1120LU, for example comprising one or more layers 201, 202, comprising for example comprising one or more of: filaments 110 comprising fibers, one or more thermoplastic materials, and one or more sheets comprising fibers, for example one or more organosheets, for example comprising fibers embedded in a thermoplastic material. For example, a filament is deposited by the FDS 2000 by advancing the FDS while supplying the filament wherein the rotating foot device 2101 or shoe guides the filament onto a surface onto which the filament is deposited. For example, the rotating foot device 2101 rotates wherein a frontal portion 2101F of the foot 2101 faces a direction of travel of the foot with respect to the substrate 200. For example, the frontal portion 2101F of the foot faces a direction that is, at a position of the foot wherein the filament is deposited, tangent to one or more of a trajectory through which the rotating axis RZ of the foot travels and a path formed by the filament deposited by the foot. For example, at the location 3015 where the filament meets the surface onto which it is deposited, the resin comprised in the filament is at a temperature greater than the glass transition temperature of the resin, for example a thermoplastic resin impregnating the filament 110.

FIG. 3A is a top view of a substrate 200, for example a build plate inside the FDS 2000, onto which 2 second preforms, for example 2 rib preforms 1121, 1122 and a first preform, for example flange preform 1110, have been formed, for example by depositing a plurality of filaments, for example using the FDS. The rib preforms are mere examples of a geometrical configuration to which a person skilled in the art will find design alternatives. For example, one or more of the rib preforms, for example 2 of the rib preforms, are used to form a buckle, for example for use on boots, ski boots, belts, and for further examples as strap buckles and ratchet buckles. For a further example, the rib preforms are part of an airfoil structure, for example wherein the flange 1110 forms one or more spars joining 2 or more ribs. For example, one or more of the ribs 1121, 1122 are bonded to the flange preform 1110 during closing of the molding unit 8100 as the mold transitions from an open configuration 8310 to a closed configuration 8320.

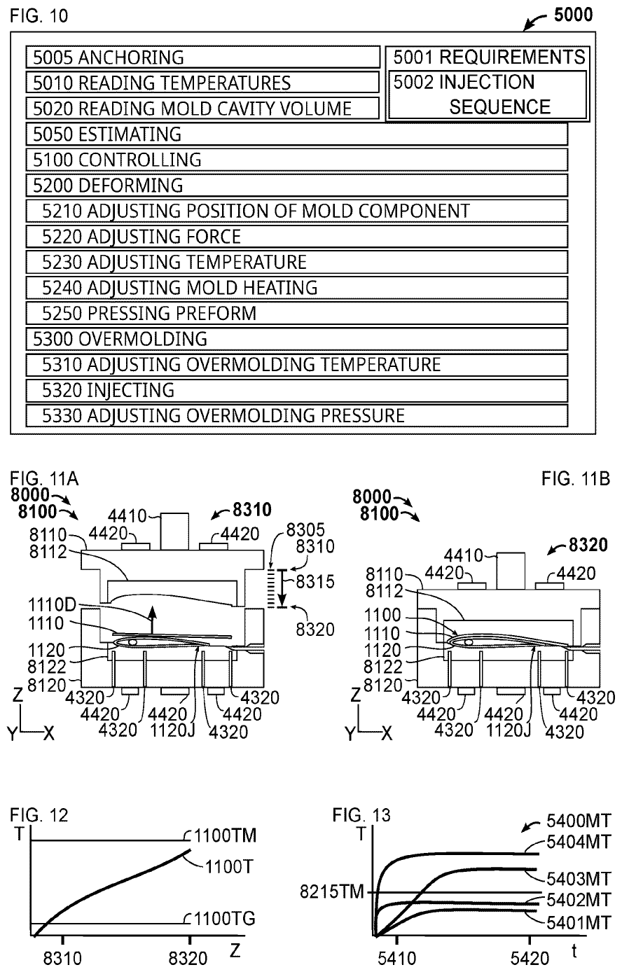

For example, one or more of the preforms, for example one or more of the ribs 1121, 1122 comprise a plurality of parallel filaments 121-1, 121-2, 122-1, 122-2, in a given deposition plane, for example a plane parallel to the X-Y plane of the substrate or build plate 200, for example arranged in a concentric pattern, for example in a loop 1120L, for example in a teardrop loop 1120TL. For example, a rib preform or a teardrop loop is configured, for example geometrically, as one or more of a cross-section of a wing and a wing section. For another example, one or more rib preforms are configured as a longitudinal cross-section of a lever, for example of a cargo door handle, a boot buckle, or a ratchet handle. For example, a teardrop loop comprises one or more filaments forming one or more loops and wherein an end of the filament 121-1E, 121-2E, 122-1E, 122-2E loops back to contact the filament, for example to form a joining point 1120J, for example in a trailing edge configuration 1121E, 1122E. For example, the end 121-1E of a first filament 121-1 and the end 121-2E of a second filament 121-2 contact a filament, for example loop back to contact the first filament 121-1 in a staircase arrangement at the joining point 1120J. For another example, a teardrop loop is formed by deformation, for example using heat, for example after additive manufacturing of a U-shaped preform, of a U-shaped preform wherein a first arm of the U joins with a second arm of the U. For example, the first arm joins asymptotically with the second arm. For example, a method of forming a preform that retains rigidity during one or more steps of deforming 5200 and pressing 5250 (FIG. 10) as the mold transitions from an open configuration 8310 to a closed configuration 8320 (FIGS. 11A and 11B) but can reconfigure itself during a step of injecting 5320 of an injection molding step, comprises forming an assembly of preforms comprising one or more teardrop preforms 1120TL. For example, one or more of the preforms, for example one or more of the flanges 1110, comprise one or more filaments 113, for example arranged in a spiral, for example a rectangular spiral. For example, the flange 1110 comprises a plurality 1110LP of layers of material. For example, each of the layers of material comprise one or more of: a thermoplastic material; a filament comprising fibers; a sheet of material, for example comprising one or more of a laminate and a foam; and an organosheet.

FIG. 3B is an isometric view of a rib preform 1120, 1121 comprising one or more stacks 1120S of filaments 121-2, 121-4. 121-6, for example formed as a layup 1120LU, extending in a stack deposition direction 1120D, for example in a Z-direction, for example orthogonal to the build plate. For example, the rib preform comprises, at one or more locations, one or more compounds 1120F. For example, the compounds 1120F are elements, for example resulting from one or more of a separate additive material deposition step and a molding step, placed against the preform. For another example, the compounds are formed directly against the preform 1120 in one or more of an additive material deposition step and a molding step. For example, the compounds comprise a filler material, for example comprising one or more of a foam and a thermoplastic. For example, the compounds have a melting temperature that is greater than a melting temperature of the thermoplastic comprised in the filaments. For example, the compounds have a melting temperature that is greater than a melting temperature of the material to be injected 8215. For example, the compounds form strengthening components that, at least within portions of the preform, resist deforming induced during one or more steps of deforming 5200 and pressing 5250 when the mold transitions from the mold's open configuration 8310 to the mold's closed configuration 8320. For example, the preform 1120 comprises a plurality 1120LP of layers of material 1120L1, 1120L2, 1120L3.

FIG. 3C is a top view of a first part 1000, RL1 shown in the molding unit 8100, for example in one or more sub-mold components 8112, 8122, for example in the second sub-mold component 8122. For example, the first part comprises one or more second preforms 1120, for example 2 preforms, for example 2 rib preforms, and one or more flange preforms 1110 that have been placed in the mold and subjected to one or more steps of: deforming 5200; pressing 5250; and overmolding 5300. In a further example, the first part 1000, RL1 further comprises a preform 1130 having filaments 114-1, 114-2 arranged in a snaking pattern comprising one or more waves 100W, 104W or curves. For example, the snaking preform 1130 comprises one or more filaments 114-1, 114-2 and one or more layers. For example, the snaking preform 1130, for example with the mold in an open configuration, is anchored 5005 at one end 1130E1 and free at an other end 1130E2. For example, the anchoring end 1130E1 has one or more of a fold and one or more layers configured to form a plug into an anchoring cavity 8122A of the mold. For example, the anchoring end 1130E1 is at an end of the snaking preform that is proximal to an outlet 8226 of the injection unit 8200. For example, the free end 1130E2 is at an end of the snaking preform that is distal from an outlet 8226 of the injection unit 8200. For example, the snaking pattern of the snaking preform 1130 comprises one or more of a spatial description of: a sinewave; a sawtooth wave; a chirp; a sequence comprising one or more U's, for example U-turns; a cycloid family of curves, for example comprising a prolate cycloid, a trochoid, an epitrochoid, and a hypotrochoid; and a curve the amplitude or width of which one or more of increases and decreases with the distance from one of the ends 1130E1, 1130E2 of the snaking preform. For example, the outlet 8226 is aligned with a midline 1130M, for example a midline between peaks, of the snaking pattern of the snaking preform 1130. For example, one or more of the outlets 8226 is adjacent to the anchor 8122A of the snaking preform 1130.

For example, in a method 5000 of manufacturing a part 1000, RL1, the snaking preform 1130 one or more of deforms elastically in the step of pressing 5250. For example, the snaking preform 1130 further deforms by one or more of melting of the thermoplastic comprised in the snaking preform and entrainment by flow, for example in a direction 8215FD, of the injected material 8215 in the step of overmolding 5300. For example, the snaking preform 1130 is subjected to a pre-insertion permanent deformation, for example by application of one or more of a heat and a force, for example a heat so that at least a portion of the snaking preform reaches a temperature equal to or greater than a glass transition temperature of the thermoplastic resin comprised within the snaking preform, prior to placing the snaking preform in the molding unit 8100. For example, the force applied results in one or more of an elongation, a shortening, a bending, and a twisting of the snaking preform 1130.

For example a method of forming a part comprising one or more filaments extending out of plane, for example having double or more curvatures, for example a first curvature around a Y-axis and a second curvature around an X-axis, comprises subjecting a snaking preform to distorting forces, one or more of: prior to placing the snaking preform inside a mold; during the pressing; and during the overmolding. For example, a method of using standard, equally sized preforms, for a range of different parts, for example differing in geometry, for example differing in scale, comprises forming preforms comprising snaking patterns and one or more of stretching and pressing the spring-like geometry of the snaking preforms, one or more of elastically and with heat, and adjusting the dimensions of the preform to the geometry and dimensions of the part to be manufactured.

FIG. 4 is a top view of a second part 1000, RL2 shown in the molding unit 8100, for example in one or more sub-mold components 8112, 8122, for example in the second sub-mold component 8122. For example, the first part comprises one or more second preforms 1120, for example 2 preforms, for example 2 rib preforms, and one or more flange preforms 1110, 1110W that have been placed in the mold and, as in the description for FIG. 3C, subjected to one or more steps of: deforming 5200; pressing 5250; and overmolding 5300. For example, the flange preform 1110W has filaments arranged in a snaking pattern over at least one or more portions 105W of the length of filaments comprised in the flange. The snaking pattern is, for example, as described for the snaking preform 1130. For example, the step of overmolding 5300 forms an overmolding over one or more portions 1100P1, 1100P2, for example at least a portion, for example comprising one or more of the snaking patterns 105W, of one or more of the preforms inside the mold. For example, one or more of the outlets 8226 is adjacent to one or more filaments of the flange preform 1110W. For example, one or more of the snaking patterns, for example each snaking pattern, intercept a longitudinal axis of one or more outlets 8226.

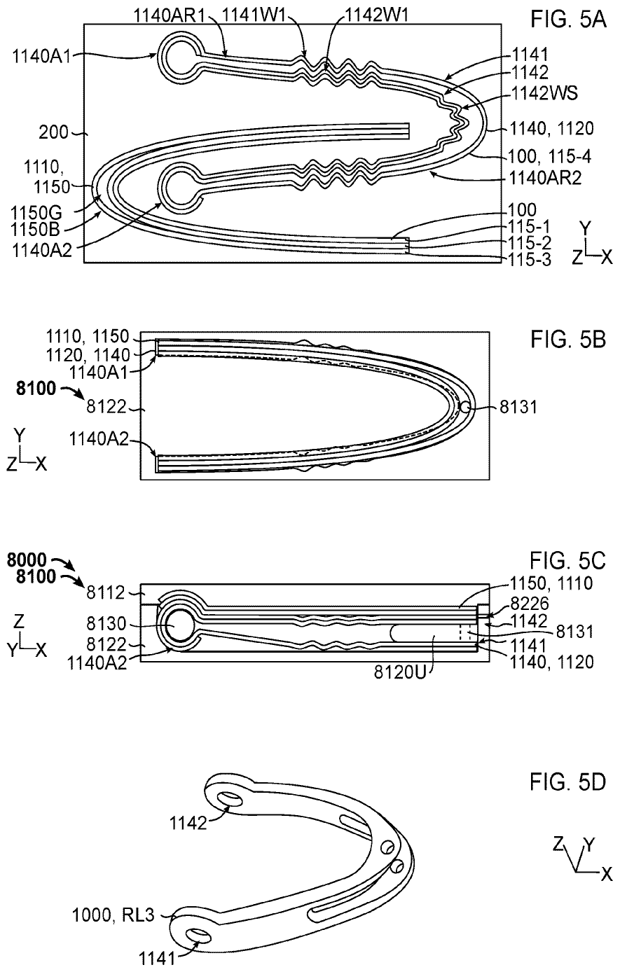

FIG. 5A is a top view of a first preform 1110, 1150 and a second preform 1120, 1140, each configured as a horseshoe. For example, the first preform 1150 and the second preform 1140 are formed on a substrate 200, for example using the FDS 2000. For example, the first horseshoe preform 1150 comprises one or more filaments 100, 115-1, 115-2, 115-3 deposited in a U pattern. For example, a first filament 115-1 is parallel and adjacent to a second filament 115-2 along an entire length of the filaments in the U pattern. For example, a third filament 115-3 is parallel and adjacent to a second filament 115-2 over one or more first length portions of the second filament, for example along one or more of the raised arm of the U pattern, but is distant from the second filament along one or more second portions of the second filament, leaving a gap 1150G, for example along the base 1150B of the U pattern.

For example, the second horseshoe preform 1140 comprises one or more filaments 100, 115-4 comprising one or more snaking patterns 1141W1, 1142W2. In the example shown in FIG. 5A, the second horseshoe preform 1140 is formed of at least one filament 115-4 per layer. Although not visible in the top view of FIG. 5A, a filament is, for example, deposited in a first layer and the depositing continues onto a second layer overlapping the first layer. For example, the second horseshoe preform 1140 comprises, for example at a first end of the horseshoe, a first anchoring loop 1140A1, and at a second end of the horseshoe, a second anchoring loop 1140A2. For example, one or more of the anchoring ends are encircled by a plurality of filament loops, for example in a given X-Y plane parallel to the substrate 200. For example, the second horseshoe preform 1140 comprises a first strand 1141, for example U-shaped, comprising one or more filaments or filament passes and a second strand 1142, for example U-shaped, comprising one or more filaments or filament passes. For example, the first filament strand 1141 and the second filament strand 1142 join at one or more ends of the horseshoe, for example at the first anchoring loop 1140A1 and at the second anchoring loop 1140A2. For example, one or more of the strands 1141, 1142 comprise one or more snaking patterns 1141W, 1142W, 1142WS. For example, a first snaking pattern 1141W extends along at least a portion of an arm of the first U-shaped strand 1141. For example, a second snaking pattern 1142W extends along at least a portion of an arm of the second U-shaped strand 1142. For example, the second snaking pattern 1142W is parallel to the first snaking pattern 1141W. For example (not shown), the second snaking pattern 1142W is parallel to the first snaking pattern 1141W and offset in the longitudinal direction of the U-shape, for example in spatial phase opposition for a periodic snaking pattern. For example, one or more of the strands 1141, 1142 comprises a third wavy pattern 1142WS at the base of the U-shape.

FIG. 5B is a top view of a molding unit 8100, for example of a sub-mold 8122, wherein the first horseshoe preform 1150 is placed against, for example over, the second horseshoe preform 1140. A method for inserting or anchoring 5005 the second horseshoe preform 1140 into the molding unit 8100 or into contact with the sub-mold 8122 comprises, for example, twisting the first anchoring loop 1140A1 and the second anchoring loop 1140A2. For example, the first anchoring loop 1140A1 is twisted counter-clockwise by, for example, 90° around substantially the longitudinal axis of its respective first arm 1140AR1 of the U-shape. For example, the second anchoring loop 1140A2 is twisted clockwise by, for example, 90° around substantially the longitudinal axis of its respective second arm 1140AR2 of the U-shape. For example, the twisting is elastic and the second horseshoe preform 1140 is inserted in tension into the mold 8100. For another example, the twisting is formed by heating at least one or more of the arms of the second horseshoe preform, for example to a temperature comprised between a glass transition temperature and a melting temperature of the resin comprised in the arms of the horseshoe. For example, upon insertion of the second horseshoe preform into the mold 8100 or into contact with the sub-mold 8122, the third wavy pattern 1142WS is stretched or contracted, for example one or more of elastically and by applying heat, for example to a temperature comprised between a glass transition temperature and a melting temperature of the resin comprised in the third wavy pattern.

FIG. 5C is a side view of a cross-section through the mold 8100 wherein the first horseshoe preform 1150 has been pressed against the second horseshoe preform 1140, for example at a temperature comprised between a glass transition temperature and a melting temperature of one or more of the first horseshoe preform and the second horseshoe preform. For example, one or more pins 8130 lock one or more of the first anchoring loop 1140A1 and the second anchoring loop 1140A2, for example by passing through one or more of the loops and orifices of one or more of the preforms 1140, 1150. For example, a further pin 8131 anchors the base of the U-shape to the mold. For example, the first strand 1141 is separated from the second strand 1142 by a separator 8120U, for example fastened to one or more of the mold 8100 and the sub-mold 8122, for example by the pin 8131. For example, the separator 8120U is inserted between the first strand 1141 and the second strand 1142 prior to insertion of the second preform 1140 into the mold 8100.

FIG. 5D is an isometric view of a third part 1000, RL3 configured as a horseshoe, after a step of overmolding and a step of extracting the part from the molding unit 8100. For example, the extracting comprises removing one or more of the pins 8130, 8131, for example prior to removing the third part from the mold 8100.

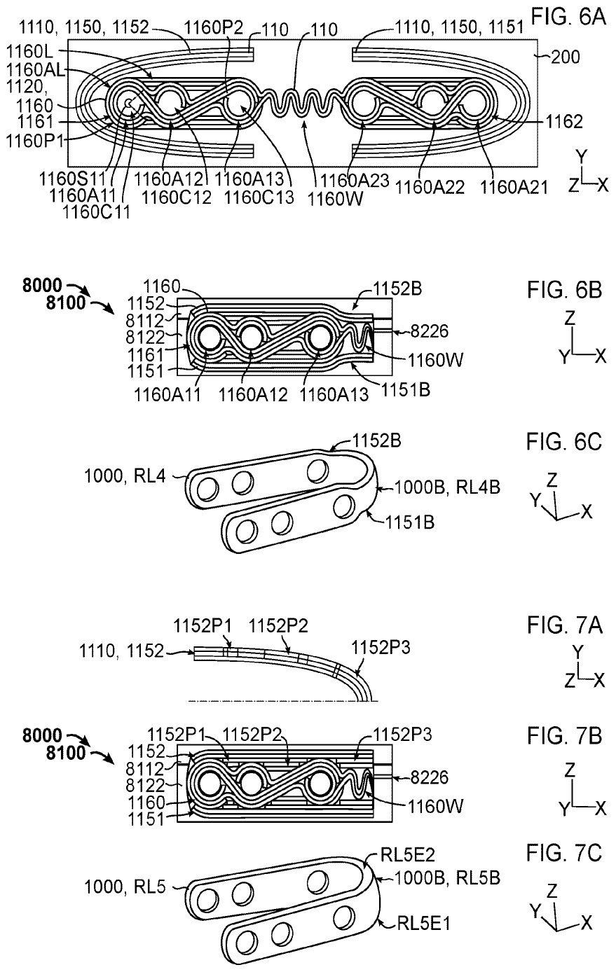

FIG. 6A is a top view of a substrate 200 comprising 2 flange horseshoe preforms 1110, 1150, 1151, 1152 and a web preform 1120, 1160 arranged for bending into a horseshoe configuration and comprising one or more filaments 110 arranged in a snaking pattern 1160W. For example, the web preform comprises a first arm 1161 and a second arm 1162 joined by the snaking pattern 1160W. For example, one or more of the arms, for example each of the arms, comprises one or more anchoring loops 1160A11, 1160A12, 1160A13, 1160A21, 1160A22, 1160A23. For example the first arm 1161 comprises one or more filaments arranged to curve around a first loop 1160A11, a second loop 1160A12, and a third loop 1160A13. For example the second arm 1162 comprises one or more filaments arranged to curve around a first loop 1160A21, a second loop 1160A22, and a third loop 1160A23. For example, the anchoring loops comprising filaments 110 are formed in one or more anchoring layers 1160AL. For example, a filament 110 forms a path around at least a portion of the circumference of one or more of the loops in the first arm 1161 and continues onto one or more waves of the snaking pattern 1160W. For example, the filament 110 further continues into the second arm 1162, forms a path around at least a portion of the circumference of one or more of the loops in the second arm.

For example, one or more of the filaments are arranged in a pulley configuration 1160P1, 1160P2. For example, a pulley configuration has a filament 110 wrapping around at least a 180° sector of a cavity or body, for example the circular cavity 1160C11 with loop 1160A11 in FIG. 6A. For example, the pulley 1160P1 continues past a second cavity 1160C12. For example, the filament, after having wrapped around the first cavity in a clockwise direction, follows the contour of one or more of a second cavity 1160C12 and a third cavity 1160C13 in a counter-clockwise direction. For another example shown as second pulley 1160P2, a filament arranged in a pulley configuration follows the contour of the first cavity in a first direction, for example clockwise or counter-clockwise, follows the contour of the second cavity in a second direction opposite that of the first direction, and follows the contour of a third cavity in the first direction. For example, a first pulley 1160P1 follows the contour of one or more cavities and continues on to a snaking pattern.

For example, one or more of the anchoring loops or pulley configuration 1160P1 are formed on a support layer 1160L. For example, the support layer 1160L comprises one or more filaments forming a loop around one or more of the orifices around which the anchoring loops are formed, for example, as shown in FIG. 6A, around 3 orifices. For example, the loop comprises one or more of: an arrangement comprising a plurality of concentric filaments; a filament arranged in a spiral; and a combination thereof. For example, one or more of the anchoring layers 1160AL are comprised in a sandwich arrangement with one or more support layers 1160L, for example in an alternating layer sandwich arrangement, for another example wherein a first sandwich component comprises a plurality of support layers 1160L and a second sandwich component comprises a plurality of anchoring layers 1160AL. In another example, the anchoring layer comprises a plurality of parallel filaments, for example arranged to form a frame (not shown) around one or more of the orifices.

FIG. 6A shows a single snaking pattern 1160W. A further example (not shown), comprises two or more snaking patterns, for example arranged side-by-side in the X-Y plane, for example wherein a second pattern has a spatial phase offset or a different spatial frequency or a different snaking design than a first snaking pattern. For yet a further example (not shown), second snaking patterns are arranged in one or more layers at Z-locations that are different from the Z-location of the first snaking pattern. For example, a method for forming a second snaking pattern comprises placing one or more sheets of material, for example one or more sheets of polyimide, between the first snaking pattern and the second snaking pattern.

FIG. 6B is a side view of a mold 8100 into which the web preform 1160 of FIG. 6A has been bent into a horseshoe configuration and, for example, sandwiched between 2 flange horseshoe preforms 1151, 1152 pressed against it, for example at a temperature comprised in range between a glass transition temperature and a melting temperature of one or more of the preforms 1160, 1151, 1152. For example, forming the horseshoe curve comprises bending the web preform 1160 around the Z-axis. For example, forming the sandwich comprises bonding a first flange horseshoe preform 1151 and a second flange horseshoe preform 1152 against a first edge and a second edge of one or more of the web preforms 1160 respectively.

FIG. 6C is an isometric view of a fourth part 1000, RL4 configured as a horseshoe. For example, the horseshoe comprises a bridge 1000B, RL4B joining the first arm and the second arm of the horseshoe. For example, the bridge RL4B of the fourth part RL4 has an extent in the Z-direction that is different from that of one or more of the arms. For example, the bridge RL4B is bonded to a bridge portion 1151B, 1152B of the flange horseshoe preform 1151, 1152. For example, a method for forming the fourth part RL4 comprises a step of forming one or more of the preforms 1160, 1151, 1152, for example on a substrate or build plate 200, for example using the FDS 2000. For example, a further step comprises removing the preforms from the build plate 200. For example, another step comprises placing a first flange 1151 into the mold 8100, for example into the bottom sub-mold 8122. For example, a further step comprises bending the web preform 1160, wherein the bending comprises forming a curve around the Z-axis, as shown in FIG. 6B. For example the bending comprises one or more of: bending elastically and bending by heating at least the snaking pattern 1160W, for example to a temperature comprised in range between a glass transition temperature and a melting temperature of one or more of snaking pattern 1160W and the web preform 1160. For example, yet a further step comprises placing a second flange 1152 into the mold 8100, for example onto the web preform 1160. For example after placement of at least portions of each of the preforms to be molded into the mold 8100, the mold is configured from an open configuration 8310 to a closed configuration 8320, for example wherein the temperature of one or more of the preforms is in a range from a glass transition temperature to a melting temperature of the resin comprised in the preforms, for example in a step of deforming 5200 the preforms. For example, 2 or more seconds, for example 10 seconds, after one or more of the mold components 8110, 8120 is configured into the closed mold configuration 8320, the injection unit 8200 is activated in a step of overmolding 5300.

FIG. 7A is a half-top view of a horseshoe preform 1110, 1152 comprising one or more filament stack portions 1152P1, 1152P2, 1152P3, for example deposited onto one or more of the horseshoe preforms 1151, 1152 presented in FIG. 6A. For example, the stack preforms are formed with one or more of a filament deposition system, for example the FDS 2000, and a rod deposition system. For example, a filament stack portion comprises one or more layers of filaments that are shorter in length than that of the filaments forming the preform onto which the stacks are formed, for example the horseshoe preform 1151, 1152.

FIG. 7B is a side view of a mold into which the web preform 1160 of FIG. 6A has been bent into a horseshoe configuration and sandwiched, for example in the Z-direction, between a first horseshoe preform 1151 and a second horseshoe preform 1152 of FIG. 7A pressed against it, for example in one or more steps of deforming 5200 and pressing 5250. For example, the filament stack portions insert themselves into one or more gaps between one or more of the anchoring loops 1160A11, 1160A12, 1160A13, 1160A21, 1160A22, 1160A23 and against the snaking pattern 1160W.

FIG. 7C is an isometric view of a fifth part 1000, RL5 configured as a horseshoe. For example the fifth part results from placing in a mold 8100: a first horseshoe preform 1151 comprising filament stacks; a web preform 1160; and a second horseshoe preform 1152 comprising filament stacks. The preforms are then subjected to one or more of: a step of deforming 5200; a step of pressing 5250; and a step of overmolding 5300. For example, the bridge RL5B of the fifth part RL5 has one or more edges, for example a bottom edge RL5E1 and a top edge RL5E2 in the Z-direction, that are coplanar with a corresponding edge of one or more of the arms of the horseshoe. For example, a method for forming a plurality of horseshoe parts having different mechanical properties comprises in a first step forming a batch of preforms, for example comprising one or more horseshoe preforms and web preforms, and, in a second step prior to placing in the mold, adding one or more stacks, for example comprising filaments, to one or more of the preforms, in effect tailoring standard preforms to specified mechanical properties requested for the part.

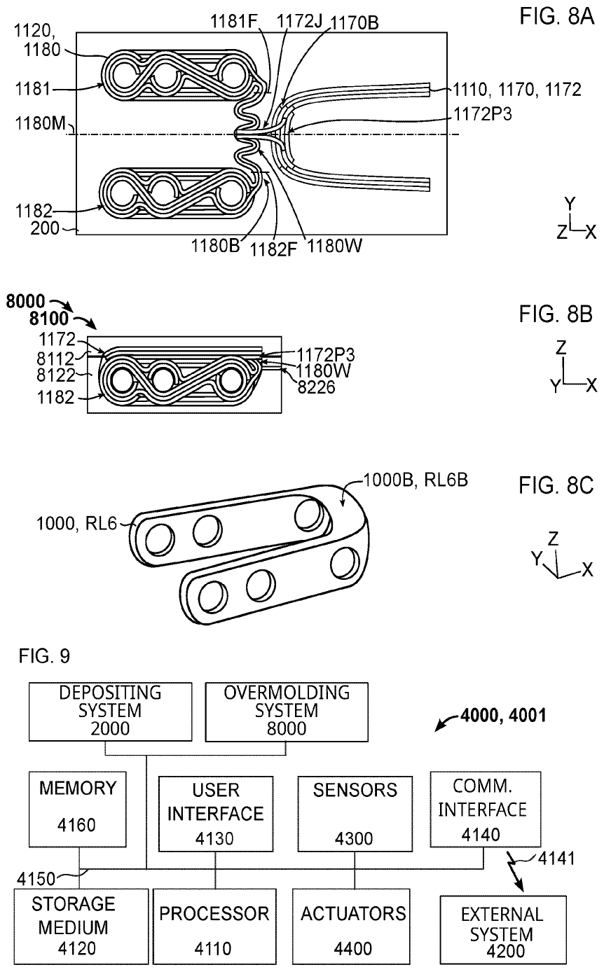

FIG. 8A is a top view of a horseshoe flange preform 1110, 1170, 1172 configured with a base 1170B of the U pattern to be pressed against a horseshoe-shaped web preform 1120, 1180 comprising a bridge 1180B configured with a snaking pattern 1180W. For example, the horseshoe-shaped web preform 1120, 1180 comprises a first arm 1181 and a second arm 1182. For example, the first arm and the second arm are configured, for example formed on a substrate 200, in a mirror arrangement, for example in a horseshoe arrangement, with respect to a midline 1180M. For example, the base 1170B comprises one or more filament stack portions 1172P3. For example, the flange preform 1172 is connected to the web preform 1180 by a joiner 1172J, for example by one or more of filaments and thermoplastic resin paths, for example joining the base 1170B to the snaking pattern 1180W. For example, a method to reduce parts count in an industrial manufacturing context comprises manufacturing one or more of the preforms with one or more joiners 1172J. For example, the joiners 1172J are one or more of cut and folded, for example using heat, upon insertion of the preforms into a mold 8100.

FIG. 8B is a side view of a mold 8100 into which the horseshoe flange preform 1110, 1170, 1172 of FIG. 8A has been pressed against the horseshoe web preform 1120, 1180 comprising a bridge 1180B. For example, a method for inserting the horseshoe-shaped web preform 1120, 1180 into the mold 8100, for example into the bottom sub-mold 8122, comprises bending one or more portions of the bridge 1180B, for example one or more of elastically and using heat, for example bringing one or more portions of the bridge to a temperature comprised between a glass transition temperature and a melt temperature. For example, upon placement in the mold, the bridge forms a convex curve raised in the Z-direction. For another example, the bridge is folded at one or more locations, for example along a first folding line 1181F and a second folding line 1182F. For example, the bridge is deformed, for example flattened, by the closing of the mold. For example, the spatial period of the waves in the snaking pattern 1180W diminishes during the closing of the mold, for example during one or more of the deforming 5200 and the pressing 5250. For example, the horseshoe flange preform 1110, 1170, 1172 has been placed onto the horseshoe web preform 1120, 1180 by folding the joiner 1172J, for example using heat, prior to closing the mold.

FIG. 8C is an isometric view of a sixth part 1000, RL6 configured as a horseshoe having a bridge 1000B, RL6B. For example, the sixth part has been removed, for example ejected, from the mold after one or more steps of: deforming 5200; pressing 5250; and overmolding 5300. For example, the bridge RL6B is substantially coplanar to or forms a convex bridge over a plane parallel to the X-Y plane. For example, each of the arms are parallel to the Z-X plane. The person skilled in the art will form different angular arrangements in one or more dimensions between the arms and the bridge.

For example, one or more of the third, fourth, fifth, and sixth parts are configured or used as a bicycle suspension shock link, a landing gear link, a vehicle suspension link, or a clevis.

FIG. 9 is a block diagram of a computer system or controller 4000, 4001 used to control one or more of a deposition system 2000 and an overmolding system 8000, for example comprising one or more of a molding unit 8100 and an injection unit 8200. For example, the computer system 4000 comprises one or more of: a processor 4110, a memory 4160, the NTCRSM 4120, the one or more sensors 4300, the one or more actuators 4400, a communication interface 4140, a user interface 4130, for example for one or more of designing, visualizing, and controlling the manufacturing of any of the preforms or parts presented in this disclosure, and a data bus 4150 for exchanging data between one or more of the computer system's components. For example, the computer system 4000 comprises a data link 4141, for example a wireless data link, for example to exchange data with one or more external systems 4200, for example one or more of the systems 2000 for applying a filament and the overmolding systems 8000. For example, one or more of the data, parameters, and instructions recited in this disclosure are stored on one or more of the NTCRSM's 4120.

FIG. 10 is a block diagram of a method 5000 for molding, for example overmolding, one or more of the preforms 1110, 1120, 1130, 1140, 1150, 1160, 1170, 1180 into a part 1000, RL1, RL2, RL3, RL4, RL5, RL6. For example, the method 5000 comprises one or more steps of anchoring 5005 one or more of preforms and parts one or more of against and into one or more of the overmolding system 8000, mold components, and sub-mold components 8112, 8122. For example, the method 5000 comprises a step of reading 5010 one or more temperature values at one or more temperature sensor locations 4320. For example, the temperature sensor locations 4320 are along the inside of the mold 8000, for example facing a contour of one or more of the loops 1120L. For example, measure a temperature value comprises inserting one or more temperature sensors into one or more of the mold and sub-molds, for example at one or more of spatial positions, for example along a surface such as the X-Y plane or a manifold, and depths, for example along the Z-axis, into one or more of the mold and sub-molds.

For example, the method 5000 comprises a step of reading a mold cavity volume 5020. For example, one or more mold cavity volumes are stored in the NTCRSM 4120. For example, the mold cavity volume comprises a three-dimensional representation of the cavity, for example within a three-dimensional representation of the mold, for example comprising a representation of the materials used in one or more or more components, for example moving components, of the mold.

For example, the method 5000 comprises a step of estimating 5050. For example, estimating comprises one or more of producing and adjusting a model, for example a two-or three-dimensional model, of temperature distributions within one or more of the overmolding system 8000, the molding unit 8100, and the injecting unit 8200. For example, the estimating is done with the computer system 4000 executing instructions, for example simulation instructions, stored in the NTCRSM 4120. For example, the results of the estimating are rendered on one or more user interfaces, for example a display, for example presenting a map, for example including a heat map, of temperatures, one or more of measured and estimated, within the mold, for example of mold components, preforms, and parts being positioned or manufactured within the mold.

For example, the method 5000 comprises a step of deforming 5200. For example, the step of deforming comprises deforming one or more of the preforms. For example, the deforming comprises deforming parts, for example molded parts. For example, the deforming is executed one or more of: outside the mold; in contact with one or more components of the mold, for example one or more sub-molds; and within the mold, for example with the mold one or more of transitioning from an open mold configuration 8310 to a closed mold configuration 8320. For example, the deforming is one or more of elastic and non-elastic, for example by heating one or more of the preforms to a temperature comprised in range between a glass transition temperature and a melting temperature of the preforms, for example of a resin comprised in the preforms.

For example, the method 5000, for example the step of deforming 5200, comprises a step of adjusting the position 5210 of one or more mold components of the mold 8000, 8110, 8120, for example of one or more of the sub-molds 8112, 8122. For example, the position is adjusted via one or more positions 8115 from the open mold configuration 8310 to the closed mold configuration 8320. For example, other mold components (not shown) are adjusted by motion in one or more of the directions X, Y, and Z, a combination thereof, one or more rotations, and one or more path-constrained motions, for example along a rail, a slider, or the surface of another mold component. For example, the motion, for example the timing and speed of the motion, is one or more of executed and controlled 5100 under one or more of instructions stored in the NTCRSM 4120 and executed by the processor 4110, for example using values, for example in a feedback control method, from one or more of the sensors 4300, for example including one or more of temperature, force, torque, and motor power consumption sensors. For example, the step of deforming 5200 further comprises one or more steps of adjusting a force 5220 of the deforming, for example adjusting one or more of a bending force, a pressing force, a stamping force, and a compressing force. For example, the step of deforming 5200 further comprises one or more steps of adjusting a temperature 5230 of the deforming, for example adjusting one or more of a bending temperature, a pressing temperature, a stamping temperature, and a compressing temperature.

For example, the method 5000 further comprises a step of adjusting a mold heating 5240. For example, the mold heating comprises one or more heaters 4420, for example comprising one or more of: a resistive heater; an inductive heater; a radiative heater; and a conductive heater, for example comprising one or more ducts for flowing a heating fluid through the mold. For example, the mold heating comprises one or more coolers (not shown), for example comprising one or more of: a conductive cooler, for example comprising ducts for flowing a cooling fluid through the mold, for another example comprising fins, for example air blown fins; and a radiative cooler, for example comprising one or more radiative surfaces. For example, the adjusting the mold heating 5240 is commanded by the controller 4000, for example following instructions stored in the NTCRSM 4120. For example, the adjusting the mold heating uses one or more of a model of the mold and a model of the preforms, for example a two-or three-dimensional model, for example stored in the NTCRSM 4120. For example, the controller 4000 one or more of measures and estimates the temperature at one or more locations of one or more of the mold and the preforms during the transitioning of the mold from the open configuration 8310 to the closed configuration 8320. For example, the controller 4000 commands the closing of the mold according to a sequence following one or more of time, closing rate, force, and temperature requirements 5001, for example stored in the NTCRSM 4120. For example, the controller commands the adjusting of one or more of the mold heating 5240, and the closing rate as a function of, for example based on, a difference in one or more of temperature and force, one or more of measured and estimated, with respect to the requirements 5001.

For example, the method 5000 further comprises a step of pressing the preforms 5250. For example, the pressing 5250 comprises switching the controller 4000 from a first mode of position control of one or more movable components of the mold to a second mode of force control of one or more of the components of the mold, for example upon detecting that force measurements are increasing beyond a threshold prior to the mold having attained the closed configuration. For example, the pressing is executed with one or more of the preforms at a temperature comprised between a glass transition temperature and a melting temperature, for example of a resin impregnating filaments comprised in the preforms. For example, the pressing includes causing a compression of filaments, for example evacuating air that is trapped between adjacent filaments. For example, the pressing causes at least the resin at the surface of the preforms in contact with the inside surface of the mold to melt. For example, the pressing causes the mold to change the surface appearance of the preforms in contact with the inside surface of the mold, for example forming one or more surface finishes on the preforms.

For example, the method 5000 further comprises a step of overmolding 5300. For example, the overmolding 5300 comprises one or more of: one or more steps of heating one or more of the injecting unit 8200 and the molding unit 8100; one or more steps of injecting 5320 the material at, for example, a controlled material supply rate; and one or more steps of adjusting 5330, for example holding, the overmolding pressure of the injected material.

For example, the material 8215 to be injected, for example a bulk molding compound (BMC) or pellet material, is heated up within the injecting unit 8200 to a melting temperature. For example, the pellet material comprises one or more of: a thermoplastic, for example a thermoplastic adhesive; a fiber, for example a chopped fiber, for example comprising one or more of a carbon fiber, a glass fiber, an aramid fiber, and a natural fiber; one or more chips, for example comprising one or more of a thermoplastic adhesive and a fiber, for example a chopped fiber. For example, a pellet has a dimension, for example in width or height, in a range from 0.5 mm to 30 mm, for example from 1 mm to 20 mm, for example from 2 mm to 10 mm. For example, the pellet originates from a recycled material, for example comprising one or more of a thermoplastic and a fiber. For example, a plurality of pellets comprises pellets having one or more of: a plurality of dimensions, chemical composition, fiber-to-plastic ratio, for example one or more of by weight and by number of fibers, color, ratio of color pellets, and spatial color distribution. For example, the melt temperature of the pellets is in a range from 63 °C to 4100 °C, for example from 100 °C to 2000 °C, for example from 200 °C to 500 °C, for example from 300 °C to 370 °C, for example from 330 °C to 340 °C, for example of 335 °C.

For example, the injecting unit is divided into one or more heating zones wherein the temperature is measured at one or more locations within each zone using one or more temperature sensors. For example, one or more of a target temperature and a heating rate is specified for one or more of the heating zones. For example, a first heating zone comprises one or more of the volume surrounding the axis of the screw 8216 and the converging duct 8222. For example, a second heating zone comprises one or more of the junction duct 8224 and the outlet 8226. For example, a further temperature specification is set for the mold for the step of injecting. For example, one or more specified temperatures and rates of heating, for example for each of the zones and the mold, are stored in the requirements 5001.

For example, for injecting of a polyamide 12 or PA12-based bulk molding compound material comprising a carbon fiber volume content in a range from 25% to 35%, for example from 28% to 32%, the temperatures are in a range from 200 °C to 340 °C. For example, example the PA12-based bulk compound material is used to overmold one or more preforms comprising a PA12 thermoplastic resin. For example, the closer the material is to the outlet 8226, the greater the specified temperature. For example, the rate of heating is in a range from 15 °C/minute to 40 °C/minute, for example 20 °C/minute to 30 °C/minute. For example, the first zone has a specified temperature in a range from 220 °C to 240 °C and a heating rate in a range from 20 °C/minute to 25 °C/minute. For example, the second zone has a specified temperature in a range from 230 °C to 250 °C and a heating rate in a range from 20 °C/minute to 25 °C/minute. For example, the mold has a specified temperature in a range from 120 °C to 200 °C, for example in a range from 120 °C to 160 °C. The values provided are merely an example that will be adjusted by the skilled person as a function of, for example based on, the volume of the injection unit, physical and rheological characteristics of the material to be injected, the volume of material to be injected and its viscosity.

For example, the step of overmolding comprises a step of injecting 5320 the overmolding material 8215 into the molding unit 8100, for example into the inside 8115 of the molding unit 8100. For example, the injecting starts 2 or more seconds after one or more of the mold components 8110, 8120 is configured into the closed mold configuration 8320 and the mold is at the specified mold temperature for the step of injecting. For example, the injecting 5320 comprises rotating the screw 8216, for example a non-reciprocating screw. For a further example, the injecting 5320 comprises translating the screw 8216, for example a reciprocating screw.

For example, an injection sequence 5002 for the step of injecting 5320 comprises a specification for one or more injection rounds, for example 3 injection rounds. For example, an injection round comprises one or more turns of the screw 8216 at a specified rate. For example, an injection round has 3 to 50 rotations at a rate of 5 to 80 rotations per second.

For example, the injection sequence further comprises instructions, for example for the step of overmolding 5300, for adjusting, for example holding, a pressure of the injected material 8215 during one or more pressure holding steps, for example 3 holding steps. For example, a pressure holding step comprises a specification for a pressure holding value and a pressure holding duration. For example, the pressure holding value is in a range from 20 bar to 300 bar, for example from 50 bar to 200 bar, for example from 60 bar to 160 bar. For example, the pressure holding duration is in a range from 3 seconds to 300 seconds, for example from 5 s to 60 s, for example from 8 s to 20 s. For example, each subsequent injection round specifies a greater number of turns of the screw and a lower rotation rate than the previous injection round. For example, each subsequent pressure holding step specifies a lower pressure than the previous pressure holding step. For example, at the end of the step of adjusting the pressure, the mold is cooled, for example one or more of: actively, for example by flowing a cooling fluid within or around the mold; and passively. For example, upon the mold reaching a suitable demolding temperature, one or more of the molded parts RL1, RL2, RL3, RL4, RL5, RL6 are one or more of ejected and removed.

For example, controlling 5100 the overmolding 5300 comprises one or more of: adjusting 5330 a pressure of the overmolding material 8215 supplied into the mold; and adjusting 5310 an overmolding temperature of the mold. For example, adjusting the supply pressure comprises one or more of: reading one or more supply pressure values from the one or more pressure sensors 43251; and estimating one or more pressure values, for example at one or more locations within the injection unit 8200, for example using one or more of: one or more of the temperature values, one or more of the compositions or references of the material to be injected 8215, values in a lookup table stored in the NTCRSM 4120 relating, for example, material composition or reference to one or more of temperature and viscosity, number of turns of the screw 8216, and turning rate of the screw. For example, the values in the lookup table relate one or more of fiber density and fiber length to values of one or more of temperature and viscosity of the material to be injected 8215.

FIG. 11A is a side view of the molding unit 8100 of the molding system 8000 of FIG. 1 in the open configuration 8310. FIG. 11B is a side view of the molding unit 8100 of the molding system 8000 of FIG. 1 in the closed configuration 8320, for example wherein one or more of the piston component 8110 and the sub-molds 8112 it carries rest against one or more counterpart mold components 8120 and sub-molds 8122. The flange preform 1110 is illustrated, for example, in a non-deformed configuration, for example in the same configuration as that upon removal from the substrate or build plate 200 upon which it was manufactured. For example, other configurations, for example a pre-deformed configuration, for example obtainable by pre-deforming using one or more of heat and force, for example manually using a heat gun, are further considered. For example, further methods for forming a preform or pre-deforming a preform include one or more steps of compression molding, overmolding, injection molding, and stamping. Shown for comparison, FIG. 11B is a side view of the molding unit of the molding system of FIG. 1 in a closed configuration. The flange preform 1110 is illustrated in its final deformed configuration.

FIG. 12 is a diagram illustrating the temperature 1100T of one or more of the molds and the preforms vs. mold position during one or more of the steps of: deforming 5200; adjusting 5210 a position of the mold components 8110, 8120; adjusting the force 5220 of the deforming; adjusting the temperature 5230 of the deforming, for example by adjusting the heating 5240; and pressing 5250 one or more of the preforms. For example, the closing of the mold starts from the open configuration 8310 wherein one or more of the temperature of the mold, for example of one or more of the sub-molds 8112, 8122, and the temperature of the preforms is greater than a glass transition temperature 1100TG of the thermoplastic resin comprised in one or more of the preforms. For example, the temperature increases during the closing, for example during the deforming of the preforms. For example, upon the mold being in a closed configuration 8320, the temperature is greatest, for example is lower than a melting temperature 1100TM of the thermoplastic resin comprised in one or more of the preforms. For example, a plurality of points of the curve 1100T are stored in NTCRSM 4120 as waypoints for guiding the deforming 5200. For example, one or more of the glass transition temperature 1100TG of the thermoplastic resin and the melting temperature 1100TM of the thermoplastic resin are stored in the NTCRSM.

FIG. 13 is a diagram 5400MT illustrating examples for the progression of temperature 1100T of one or more of the molds 8000, mold components, sub-molds, and preforms vs. time during one or more of the steps of: overmolding 5300; adjusting the overmolding temperature 5310; injecting 5320; and adjusting overmolding pressure 5330. The examples are illustrated with respect to the melting temperature 8215TM of the material being injected 8215. For a first temperature progression example 5401MT the temperature is increasing one or more of before and after the start 5410 of the step of overmolding 5300. For example, the temperature one or more of reaches a maximum and stabilizes one or more of prior to and upon reaching the end 5420 of the step of overmolding. For example, the end 5420 of the step of overmolding is triggered by the end of the step of adjusting the overmolding pressure 5330. For example, the temperature remains below the melting temperature 8215TM of the material being injected 8215. For a second temperature progression example 5402MT the temperature is increased to a specified value prior to the start 5410 of the step of overmolding 5300, for example below the melting temperature 8215TM of the material being injected 8215, and remains substantially constant, for example by adjusting 5310 the temperature of the mold unit 8100, until the end 5420 of the step of overmolding. For a third temperature progression example 5403MT the temperature increases to a temperature greater than the melting temperature 8215TM of the material being injected 8215, for example after the start 5410 of the step of overmolding 5300. For example, the temperature remains greater than the melting temperature 8215TM until the end 5420 of the step of overmolding. For a fourth temperature progression example 5404MT the temperature increases to a temperature greater than the melting temperature 8215TM of the material being injected 8215 prior to the start 5410 of the step of overmolding 5300. For example, the mold 8000 is cooled upon reaching the end 5420 of the step of overmolding.

In summary, this disclosure teaches a method 5000 for molding one or more first preforms 1110 against one or more second preforms 1120 inside a mold 8000 comprising a first mold component 8110 and a second mold component 8120. For example, the method comprises the steps: deforming 5200 one or more of the preforms 1110, 1120 by adjusting 5210 a position 8305 of one or more of the mold components configured for pressing 5250 one or more of the first preforms against one or more of the second preforms in an inside 8115 of the mold; and overmolding 5300 at least a portion 1100P1, 1100P2 of one or more of the preforms inside the mold. For example in the method, the overmolding comprises injecting 5320 an overmolding material 8215 comprising an overmolding thermoplastic resin and causing a flow direction 8215FD of the overmolding material along at least a portion of the inside 8115P of the mold. For example in the method, each of the preforms 1110, 1120 comprises a thermoplastic resin. For example in the method, the deforming comprises controlling 5100: i) a force of the deforming 5200 exerted by one or more motion actuators 4410 at one or more positions of the mold components, wherein the motion actuators are connected to one or more of the mold components 8110, 8120 and having an actuation range 8315 extending via a plurality of positions of one or more of the mold components from one or more of an open mold position configuration 8310 to a closed mold position configuration 8320; ii) a temperature of the deforming 5200 at one or more of the positions 8305 of one or more of the mold components, wherein the temperature of the deforming sets one or more of the first preforms and one or more of the second preforms against which the first preforms are pressed to be at one or more preform temperatures 1100T that are above a glass transition temperature 1100TG and below a melting temperature 1100TM of the preforms 1110, 1120; and iii) a temperature 5400MT of the mold during the step of overmolding 5300 wherein one or more of the mold components 8110, 8120 are configured in the closed mold configuration 8320.

In an aggregated summary, this disclosure teaches a method 5000 for molding one or more first preforms 1110 against one or more second preforms 1120 inside a mold 8000 comprising a first mold component 8110 and a second mold component 8120, the method comprising the steps: deforming 5200 one or more of the preforms 1110, 1120 by adjusting 5210 a position 8305 of one or more of the mold components configured for pressing 5250 one or more of the first preforms against one or more of the second preforms in an inside 8115 of the mold; and overmolding 5300 at least a portion 1100P1, 1100P2 of one or more of the preforms inside the mold, wherein the overmolding comprises injecting 5320 an overmolding material 8215 comprising an overmolding thermoplastic resin and causing a flow direction 8215FD of the overmolding material along at least a portion of the inside 8115P of the mold, wherein each of the preforms 1110, 1120 comprises a thermoplastic resin and wherein the deforming comprises controlling 5100: i) a force of the deforming 5200 exerted by one or more motion actuators 4410 at one or more positions of the mold components, wherein the motion actuators are connected to one or more of the mold components 8110, 8120 and having an actuation range 8315 extending via a plurality of positions of one or more of the mold components from one or more of an open mold position configuration 8310 to a closed mold position configuration 8320; ii) a temperature of the deforming 5200 at one or more of the positions 8315 of one or more of the mold components, wherein the temperature of the deforming sets one or more of the first preforms and one or more of the second preforms against which the first preforms are pressed to be at one or more preform temperatures 1100T that are above a glass transition temperature 1100TG and below a melting temperature 1100TM of the preforms 1110, 1120; and iii) a temperature 5400MT of the mold during the step of overmolding 5300 wherein one or more of the mold components 8110, 8120 are configured in the closed mold configuration 8320.

For example, the temperature 5400MT of the mold during the step of overmolding 5300 is at a temperature that is equal to or greater than a melting temperature of the thermoplastic resin comprised in the preforms. For example, the temperature 5400MT of the mold during the step of overmolding 5300 is selected from one or more of a lookup table and a function relating a viscosity of the overmolding material 8215 to a temperature of the overmolding material. For example, the overmolding material comprises a filler material selected from the group including: microspheres, chopped fibers, discontinuous fibers, short fibers, and recycled fibers. For example, one or more of the first preforms 1110 and one or more of the second preforms 1120 comprise fibers. For example, one or more of the first preforms 1110 and one or more of the second preforms 1120 comprise continuous fibers. For example, the step of overmolding starts 2 or more seconds after one or more of the mold components 8110, 8120 is configured into the closed mold configuration 8320.

For example, each of the first preform 1110 and the second preform 1120 comprise fibers 110F, 110FD, 110FD1, 110FD2; a first surface portion 1110P of the first preform contacts a second surface portion 1120P of the second preform; and wherein a plurality of fibers in the first surface portion are parallel to a plurality of fibers in the second surface portion. For example, the first surface portion 1110P is deformed against the second surface portion 1120P. For example, one or more of the second preforms 1120 forms a loop 1120L and is convex in the second surface portion 1120P. For example, the loop 1120L is configured as a teardrop loop 1120TL. For example, the method further comprises reading 5010 one or more temperature values at one or more locations 4320 along the inside of the mold 8000 facing a contour of the loop 1120L.

For example, the first preform 1110 comprises a first layup 1110LU comprising a first plurality of first layers 1110LP comprising one or more filaments 110, 111, 112, 113 comprising fibers 110F, 110FD1, 110FD2 forming a first stack 1110S extending in a first stack direction 1110D; the second preform 1120 comprises a second layup 1120LU comprising a second plurality of second layers 1120LP comprising one or more filaments 110, 121-1, 121-2, 121-4, 121-6, 122-1, 122-2 comprising fibers forming a second stack 1120S extending in a second stack direction 1120D; and wherein the second direction 1120D is orthogonal to the first direction 1110D.

For example, the method further comprises a third preform 1122, 1130 inside the mold 8000. For example, one or more of the preforms 1110, 1120, 1130 comprises a layup 1110LU, 1120LU comprising one or more layers 201, 202 comprising one or more filaments 110, 110FD, 111, 112, 113, 121-1, 121-2, 121-4, 121-6, 122-1, 122-2. For example, one or more of the filaments 110, 111, 112, 113, 121-1, 121-2, 121-4, 121-6, 122-1, 122-2 comprise continuous fibers 110F. For example, one or more of the preforms 1130, 1110W comprise one or more filaments 100, 114-1, 114-2 comprising at least a portion arranged in a snaking pattern 100W, 104W, 105W, 1141W1, 1142W2, 1142WS, 1180W.

For example, one or more of the preforms 1130 comprise a first end 1130E1 of the preform that is anchored to the mold 8000 at an anchor point 8122A that is upstream with respect to the flow direction 8215FD of the overmolding material 8215 of a second end 1130E2 of the preform that is free-floating. For example, one or more of the preforms 1130, 1110W comprise one or more portions configured in a snaking pattern 100W, 104W, 105W, 1141W1, 1142W2, 1142WS, 1180W. For example, the mold comprises one or more anchor points 8122A for anchoring one or more preforms that are upstream of one or more of the outlets 8226. For example, one or more of the outlets are arranged so that an outflow of resin through the outlet is predominantly in the flow direction 8215FD. For example, one or more of the preforms 1110, 1120, 1130 are anchored to the mold 8000 at one or more of the anchor points 8122A.

For example, the method further comprises one or more third preforms 1130 inside the mold 8000, wherein the third preforms comprise a first end 1130E1 of the preform that is anchored to the mold 8000 at an anchor point 8122A that is upstream with respect to the flow direction 8215FD of the overmolding material 8215 of a second end 1130E2 of the preform that is free-floating and wherein the third preforms comprise one or more portions 100W, 104W configured in a snaking pattern. For example, one or more of the preforms 1110, 1120, 1130 comprise one or more filaments 100, 114-1, 114-2 configured as tapes 110, 110FD having a rectangular cross-section and comprising fibers 110F, 110FD1, 110FD2. For example, the tape 110FD comprises continuous fibers 110F. For example, the method further comprises reading 5010 one or more temperature values at one or more locations 4320 along the inside of the mold 8000 facing one or more of the preforms 1110, 11120, 1130. For example, the overmolding further comprises controlling the pressure 5330 of supplying the overmolding material 8215 during the injecting 5320 as a function of, for example based on, one or more of the temperature values at one or more locations 4319 along the inside of the mold 8000 facing one or more of the preforms 1110, 11120, 1130. For example, the overmolding further comprises controlling the pressure 5330 of supplying the overmolding material 8215 during the injecting 5320. For example, one or more first preforms 1110 are connected to one or more second preforms 1120 by one or more joints comprising a thermoplastic material.

This disclosure further teaches a mold 8000 for molding one or more first preforms 1110 against one or more second preforms 1120, the mold comprising: one or more first mold components 8110 and one or more second mold components 8120; one or more motion actuators 4410 connected to one or more of the mold components 8110, 8120 and having an actuation range 8315 extending via a plurality of mold positions from one or more of an open mold position configuration 8310 to a closed mold position configuration 8320; one or more heating devices 4420, each connected to one or more of the mold components 8110, 8120, for heating one or more of the mold components and the preforms; one or more outlets 8226 feeding into an inside 8115 of the mold; and a controller 4001 connected to one or more of the heating devices 4420 and to one or more of the motion actuators 4410, wherein the controller comprises instructions for: i) adjusting a force 5220 exerted by one or more of the motion actuators at one or more of the mold positions 8305; ii) adjusting a temperature 5230 at one or more of the mold positions within the actuation range 8315; and iii) adjusting an overmolding temperature 5310 of the mold for overmolding 5300 upon one or more of the mold components 8110, 8120 being configured in the closed mold configuration 8320.

For example, the adjusting a temperature 5230 is to a value in a range between a preform resin glass transition temperature 1100TG and a preform resin melting temperature 1100TM of one or more of the preforms 1110, 1120, 1130. For example, one or more of the preform resin glass transition temperature 1100TG and the preform resin melting temperature 1100TM are stored in the NTCRSM. For example, the mold comprises one or more temperature sensors 4320. For example, the adjusting a temperature 5230 comprises adjusting a mold heating 5240 supplied by one or more of the heating devices 4420. For example, the adjusting the overmolding temperature 5310 comprises adjusting a mold heating 5240 supplied by one or more of the heating devices 4420. For example, the instructions for adjusting a force 5220 comprise instructions for reading measurements from one or more of the temperature sensors 4320.

For example, the mold further comprises an injection unit 8200. For example, the controller further comprises instructions to activate an injection unit 8200 2 or more seconds after one or more of the mold components 8110, 8120 is configured into the closed mold configuration 8320. For example, the controller further comprises instructions for: i) reading temperatures 5010 for a resin glass transition temperature 1100TG and a resin melting temperature 1100TM; ii) reading a mold cavity volume 5020; and iii) estimating 5050 one or more of a pressure value and a pressurization duration for one or more pressurization steps of an overmolding step 5300 of a molding method 5000. For example, the controller further comprises instructions for: i) reading 5010 one or more of temperature values at one or more locations within the mold 8000; and ii) adjusting the pressure 5330 of supplying an overmolding material 8215 during one or more steps of an overmolding step 5300.

1. A method (5000) for molding one or more first preforms (1110) against one or more second preforms (1120) inside a mold (8000) comprising a first mold component (8110) and a second mold component (8120), the method comprising the steps:
deforming (5200) one or more of the preforms (1110, 1120) by adjusting (5210) a position (8305) of one or more of the mold components configured for pressing (5250) one or more of the first preforms against one or more of the second preforms in an inside (8115) of the mold; and
overmolding (5300) at least a portion (1100P1, 1100P2) of one or more of the preforms inside the mold, wherein the overmolding comprises injecting (5320) an overmolding material (8215) comprising an overmolding thermoplastic resin and causing a flow direction (8215FD) of the overmolding material along at least a portion (8115P) of the inside (8115) of the mold,
wherein each of the preforms (1110, 1120) comprises a thermoplastic resin and wherein the deforming comprises controlling (5100):
i) a force of the deforming (5200) exerted by one or more motion actuators (4410) at one or more of the positions (8305) of the mold components, wherein the motion actuators are connected to one or more of the mold components (8110, 8120) and having an actuation range (8315) extending via a plurality of the positions of one or more of the mold components from one or more of an open mold position configuration (8310) to a closed mold position configuration (8320);
ii) a temperature of the deforming (5200) at one or more of the positions (8315) of one or more of the mold components, wherein the temperature of the deforming sets one or more of the first preforms and one or more of the second preforms against which the first preforms are pressed to be at one or more preform temperatures (1100T) that are above a glass transition temperature (1100TG) and below a melting temperature (1100TM) of the preforms (1110, 1120); and
iii) a temperature (5400MT) of the mold during the step of overmolding (5300) wherein one or more of the mold components (8110, 8120) are configured in the closed mold configuration (8320).

2. The method according to claim 1, wherein the temperature of the mold (5400MT) during the step of overmolding (5300) is at a temperature that is equal to or greater than a melting temperature of a thermoplastic resin comprised in the preforms.

3. The method according to claim 1, wherein the temperature of the mold (5400MT) during the step of overmolding (5300) is selected from one or more of a lookup table and a function relating a viscosity of the overmolding material (8215) to a temperature of the overmolding material.

4. The method according to claim 1, wherein the overmolding material comprises a filler material selected from the group including: microspheres, chopped fibers, discontinuous fibers, short fibers, and recycled fibers.

5. The method according to claim 1, wherein one or more of the first preforms (1110) and one or more of the second preforms (1120) comprise fibers.

6. The method according to claim 1, wherein one or more of the first preforms (1110) and one or more of the second preforms (1120) comprise continuous fibers.

7. The method according to claim 1, wherein the step of overmolding starts 2 or more seconds after one or more of the mold components (8110, 8120) is configured into the closed mold configuration (8320).

8. The method according to claim 1, wherein:
each of the first preform (1110) and the second preform (1120) comprise fibers (110F, 110FD, 110FD1, 110FD2);
a first surface portion (1110P) of the first preform contacts a second surface portion (1120P) of the second preform;
and wherein a plurality of fibers in the first surface portion are parallel to a plurality of fibers in the second surface portion.

9. The method according to claim 8, wherein the first surface portion (1110P) is deformed against the second surface portion (1120P).

10. The method according to claim 8, wherein one or more of the second preforms (1120) forms a loop (1120L) and is convex in the second surface portion (1120P).

11. The method according to claim 10, wherein the loop (1120L) is configured as a teardrop loop (1120TL).

12. The method according to claim 10, further comprising reading (5010) one or more temperature values at one or more locations (4320) along the inside of the mold (8000) facing a contour of the loop (1120L).

13. The method according to claim 1, wherein:
the first preform (1110) comprises a first layup (1110LU) comprising a first plurality of first layers (1110LP) comprising one or more filaments (110, 111,112,113) comprising fibers (110F, 110FD1, 110FD2) forming a first stack (1110S) extending in a first stack direction (1110D);
the second preform (1120) comprises a second layup (1120LU) comprising a second plurality of second layers (1120LP) comprising one or more filaments (110, 121-1, 121-2, 121-4, 121-6, 122-1, 122-2) comprising fibers forming a second stack (1120S) extending in a second stack direction (1120D); and
wherein the second direction (1120D) is orthogonal to the first direction (1110D).

14. The method according to claim 1, further comprising a third preform (1122, 1130) inside the mold (8000).

15. The method according to claim 1, wherein one or more of the preforms (1110, 1120, 1130) comprises a layup (1110LU, 1120LU) comprising one or more layers (201, 202) comprising one or more filaments (110, 110FD, 111, 112, 113, 121-1, 121-2, 121-4, 121-6, 122-1, 122-2).

16. The method according to claim 15, wherein one or more of the filaments (110, 111, 112, 113, 121-1, 121-2, 121-4, 121-6, 122-1, 122-2) comprise continuous fibers (110F).

17. The method according to claim 1, wherein one or more of the preforms (1130, 1110W) comprise one or more filaments (100, 114-1, 114-2) comprising at least a portion arranged in a snaking pattern (100W, 104W, 105W, 1141W1, 1142W2, 1142WS, 1180W).

18. The method according to claim 1, wherein one or more of the preforms (1130) comprise a first end (1130E1) of the preform that is anchored (5005) to the mold (8000) at an anchor point (8122A) that is upstream with respect to the flow direction (8215FD) of the overmolding material (8215) of a second end (1130E2) of the preform that is free-floating.

19. The method according to claim 18, wherein one or more of the preforms (1130, 1110W) comprise one or more portions configured in a snaking pattern (100W, 104W, 105W, 1141W1, 1142W2, 1142WS, 1180W).

20. The method according to claim 1, further comprising one or more third preforms (1130) inside the mold (8000), wherein the third preforms comprise a first end (1130E1) of the preform that is anchored to the mold (8000) at an anchor point (8122A) that is upstream with respect to the flow direction (8215FD) of the overmolding material (8215) of a second end (1130E2) of the preform that is free-floating and wherein the third preforms comprise one or more portions (100W, 104W) configured in a snaking pattern.

21. The method according to claim 1, wherein one or more of the preforms (1110, 1120, 1130) comprise one or more filaments (100, 114-1, 114-2) configured as tapes (110, 110FD) having a rectangular cross-section and comprising fibers (110F, 110FD1, 110FD2).

22. The method according to claim 21, wherein the tape (110FD) comprises continuous fibers (110F).

23. The method according to claim 1, further comprising reading (5010) one or more temperature values at one or more locations (4320) along the inside of the mold (8000) facing one or more of the preforms (1110, 11120, 1130).

24. The method according to claim 23, wherein the overmolding further comprises controlling the pressure (5330) of supplying the overmolding material (8215) during the injecting (5320) based on one or more of the temperature values at one or more locations (4319) along the inside of the mold (8000) facing one or more of the preforms (1110, 11120, 1130).

25. The method according to claim 1, wherein the overmolding further comprises controlling the pressure (5330) of supplying the overmolding material (8215) during the injecting (5320).

26. The method according to claim 1, wherein one or more first preforms (1110) are connected to one or more second preforms (1120) by one or more joints comprising a thermoplastic material.

27. A mold (8000) for molding one or more first preforms (1110) against one or more second preforms (1120), the mold comprising:
one or more first mold components (8110) and one or more second mold components (8120);
one or more motion actuators (4410) connected to one or more of the mold components (8110, 8120) and having an actuation range (8315) extending via a plurality of mold positions (8305) from one or more of an open mold position configuration (8310) to a closed mold position configuration (8320);
one or more heating devices (4420), each connected to one or more of the mold components (8110, 8120), for heating one or more of the mold components and the preforms;
one or more outlets (8226) feeding into an inside (8115) of the mold; and
a controller (4001) connected to one or more of the heating devices (4420) and to one or more of the motion actuators (4410), wherein the controller comprises instructions for:
i) adjusting a force (5220) exerted by one or more of the motion actuators at one or more of the mold positions (8305);
ii) adjusting a temperature (5230) at one or more of the mold positions within the actuation range (8315); and
iii) adjusting an overmolding temperature (5310) of the mold for overmolding (5300) upon one or more of the mold components (8110, 8120) being configured in the closed mold configuration (8320).

28. The mold according to claim 27, wherein the adjusting a temperature (5230) is to a value in a range between a preform resin glass transition temperature (1100TG) and a preform resin melting temperature (1100TM) of one or more of the preforms (1110, 1120, 1130).

29. The mold according to claim 27, wherein the mold comprises one or more temperature sensors (4320).

30. The mold according to claim 27, wherein the adjusting a temperature (5230) comprises adjusting a mold heating (5240) supplied by one or more of the heating devices (4420).

31. The mold according to claim 27, wherein the adjusting the overmolding temperature (5310) comprises adjusting a mold heating (5240) supplied by one or more of the heating devices (4420).

32. The mold according to claim 27, wherein the mold comprises one or more anchor points (8122A) for anchoring one or more preforms that are upstream of one or more of the outlets (8226).

33. The mold according to claim 27, wherein the instructions for adjusting a force (5220) comprise instructions for reading measurements from one or more of the temperature sensors (4320).

34. The mold according to claim 27, further comprising an injection unit (8200).

35. The mold according to claim 27, wherein the controller further comprises instructions to activate an injection unit (8200) 2 or more seconds after one or more of the mold components (8110, 8120) is configured into the closed mold configuration (8320).

36. The mold according to claim 27, wherein the controller further comprises instructions for:
i) reading temperatures (5010) for a resin glass transition temperature (1100TG) and a resin melting temperature (1100TM);
ii) reading a mold cavity volume (5020); and
iii) estimating (5050) one or more of a pressure value and a pressurization duration for one or more pressurization steps of an overmolding step (5300) of a molding method (5000).

37. The mold according to claim 27, wherein the controller further comprises instructions for:
i) reading (5010) one or more of temperature values at one or more locations within the mold (8000); and
ii) adjusting the pressure (5330) of supplying an overmolding material (8215) during one or more steps of an overmolding step (5300).
